(19) United States
(12) Patent Application Publication
(10) Pub. No.: US 2016/0144972 A1
(43) Pub. Date: May 26, 2016

(54) Blended Wing Body Boundary Layer Ingesting Inlet Design Integration

(71) Applicant: United Technologies Corporation, Hartford, CT (US)

(72) Inventors: Razvan Virgil Florea, Manchester, CT (US); Mark B. Stucky, Glastonbury, CT (US)

(73) Assignee: United Technologies Corporation, Hartford, CT (US)

(21) Appl. No.: 14/295,578

(22) Filed: Jun. 4, 2014

Related U.S. Application Data
(60) Provisional application No. 61/862,541, filed on Aug. 6, 2013.

(51) Int. Cl. B64D 33/02; B64C 39/10

(52) U.S. Cl. CPC B64D 33/02; B64C 39/10; B64D 2033/0226; B64D 2033/0253; B64D 2033/0273

(57) ABSTRACT

An inlet for a propulsion system has an upper wall and a lower wall and a throat extending between the upper wall and the lower wall. The lower wall has a bump edge located immediately after the throat.

### CROSS REFERENCE TO RELATED APPLICATION

This application claims the benefit of provisional application Ser. No. 61/862,541, filed Aug. 6, 2013.

### STATEMENT OF GOVERNMENT INTEREST

The subject matter described herein was made with government support under Contract No. NNC07CB59C awarded by NASA. The government of the United States of America may have rights to the subject matter described herein.

### BACKGROUND

The present disclosure is directed to an inlet design for a propulsion system for ensuring a smooth integration of the boundary layer ingestion.

A key goal of the next-generation of air vehicles and propulsion systems is to provide dramatic reductions in noise, emissions, and fuel burn relative to conventional aircraft and current gas turbine engines. One path to achieving this is to advance the design capabilities for embedded engines in blended wing body aircraft.

The goal is to develop boundary layer ingesting propulsion systems, which can provide improvements in propulsive efficiency by producing thrust from the reduced velocity boundary layer air. The challenges is then shifted from the airframe to the propulsion system where the high inlet flow distortion drives performance, aeromechanical, stability/operability and acoustic issues within the compression system. The inlet duct and fan function as a system. The large flow distortions lead to strong coupling between the fan and upstream flow fields.

### SUMMARY

The present disclosure illustrates a distortion-tolerant propulsion system that simultaneously minimizes reduction in fan efficiency and stall margin relative to a clean-inflow conventional baseline. Specifically, there is provided boundary layer ingesting inlet integration as part of the distortion-tolerant propulsion system and blended wing body wall modification upstream of the inlet.

In accordance with the present disclosure, there is provided an inlet for a propulsion system which broadly includes an upper wall and a lower wall, a throat extending between the upper wall and the lower wall, and the lower wall having a bump edge located downstream of the throat.

In another and alternative embodiment, the bump edge may additionally and/or alternatively have an upwardly inclined portion, a flat portion, and a downwardly inclined portion.

In another and alternative embodiment, the upwardly inclined portion may additionally and/or alternatively be inclined at an angle of from about 20 to about 30 degrees.

In another and alternative embodiment, the flat portion may additionally and/or alternatively extend about 10 to 20% of the overall length of the bump edge.

In another and alternative embodiment, the throat may additionally and/or alternatively have a first height and the bump edge may additionally and/or alternatively have a second height which is about 0.25 to about 1.0% of the first height.

In another and alternative embodiment, the upper wall may additionally and/or alternatively form a leading edge inlet lip and may additionally and/or alternatively have an arcuate shape at the leading edge inlet lip.

In another and alternative embodiment, the upper wall forming the leading edge inlet lip may additionally and/or alternatively have a U-shaped profile.

In another and alternative embodiment, the upper wall forming the leading edge inlet lip may additionally and/or alternatively be joined at a trailing edge to a casing surrounding the propulsion system.

In another and alternative embodiment, the lower wall may additionally and/or alternatively have a leading edge and may additionally and/or alternatively be a continuation of a surface of an airframe.

In another embodiment, the inlet may additionally and/or alternatively further comprise a smooth transition at the leading edge of the lower wall.

In accordance with the present disclosure, there is also provided a propulsion system which broadly includes any of the foregoing inlet embodiments, a compressor in fluid communication with the inlet, and a turbine configured to drive the compressor.

Other details of the blended wing body boundary layer ingesting inlet design integration are set forth in the following detailed description and the accompanying drawings wherein like reference numerals depict like elements.

### BRIEF DESCRIPTION OF THE DRAWINGS

FIG. 1 illustrates an embodiment of a blended wing body aircraft having an embedded engine;

FIG. 2 illustrates an embodiment of an embedded engine;

FIG. 3 illustrates an embodiment of an inlet for a propulsion system;

FIG. 4 is an exploded view of a bump edge used in the inlet design of FIG. 3;

FIG. 5 is a cross sectional view of the bump edge of FIG. 4; and

FIG. 6 is a front view of the propulsion system inlet of FIG. 3.

### DETAILED DESCRIPTION

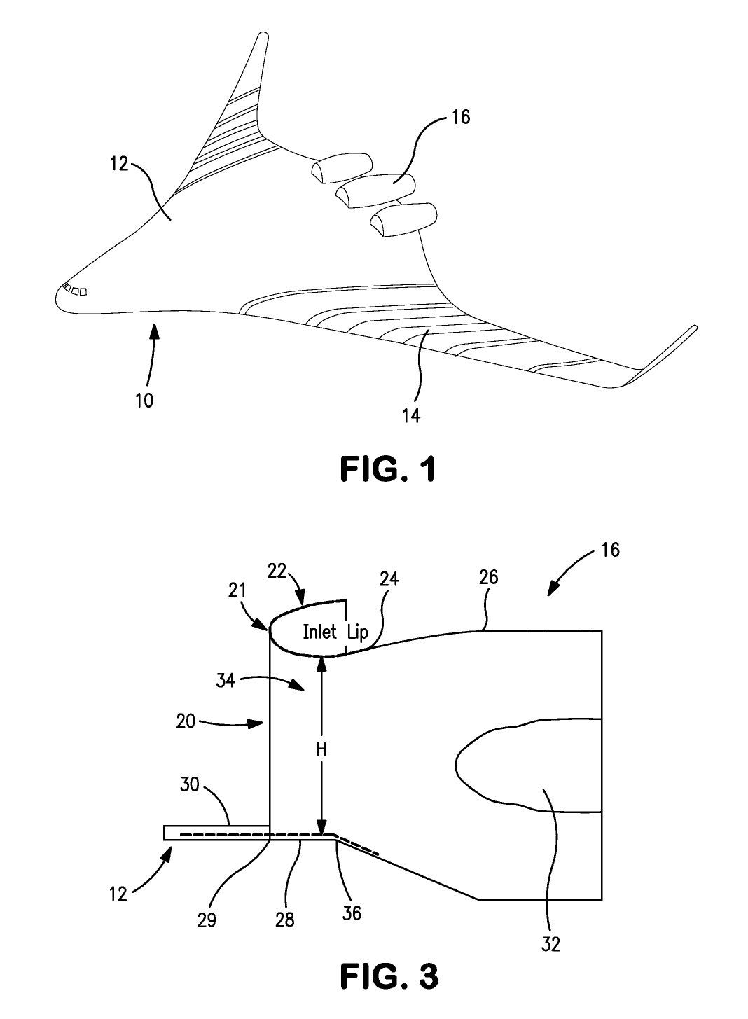

Referring now to FIG. 1, there is illustrated a blended wing body aircraft 10 having a fuselage 12, wings 14, and embedded engines 16. While a particular blended wing body aircraft 10 has been provided, it should be recognized that the propulsion system inlet design described herein may be used with a wide variety of aircraft having embedded engines. The propulsion system inlet design may also be used on propulsion systems which are not embedded engines.

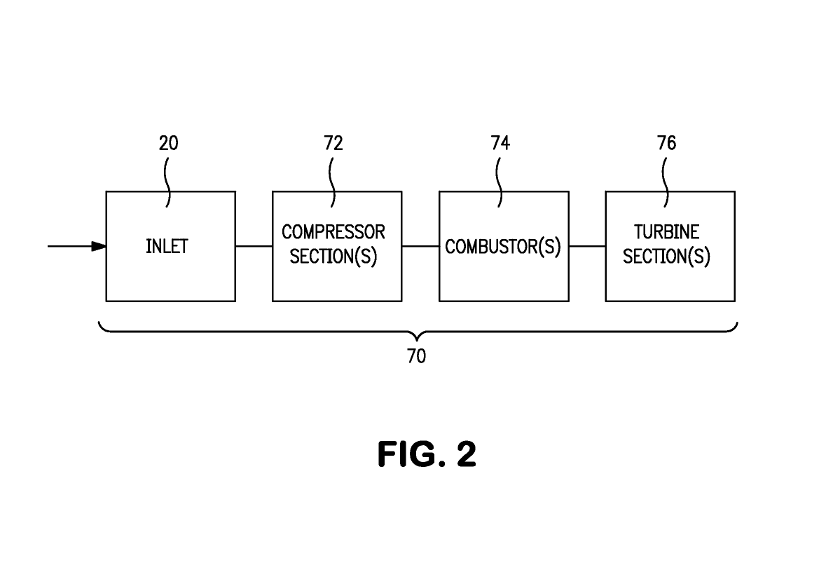

The embedded engines 16 may comprise any propulsion engine such as a gas turbine engine. Moreover, the embedded engine, as shown in FIG. 2, may comprise a propulsion system 70 that includes at least one compressor section 72 in fluid communication with an inlet 20. Air, which is delivered into the at least one compressor section 72 via the inlet 20, is compressed in the at least one compressor section 72 and thereafter delivered into a combustor 74. In the combustor 74, fuel is added to the compressed air and the mixture is ignited. The byproducts of the combustion process are directed across one or more turbine sections 76, which are connected to the one or more compressor sections 72, thereby causing rotation of the turbine and compressor sections 72 and 76, respectively.

Referring now to FIGS. 3-6, the embedded engine 16 forming the propulsion system has an inlet 20. The inlet 20 has a leading edge inlet lip 21 which is formed by an arcuate shaped upper wall 22 having a U-shaped profile. The upper wall 22 is joined at its trailing edge 24 to a casing 26 which surrounds each embedded engine 16 forming the propulsion system. The inlet 20 is further formed by a lower wall 28 which is a continuation of a surface 30 of the blended wing body fuselage 12. The lower wall 28 has a leading edge 29 and the transition from the surface 30 to the lower wall 28 at the leading edge is substantially smooth.

A centerbody 32 may be located within the inlet 20. The centerbody 32 causes the flow within the inlet 20 to be divided into different gas paths.

The inlet 20 has a throat 34. The throat 34 is the shortest height H of the inlet 20 between the upper wall 22 and the lower wall 28.

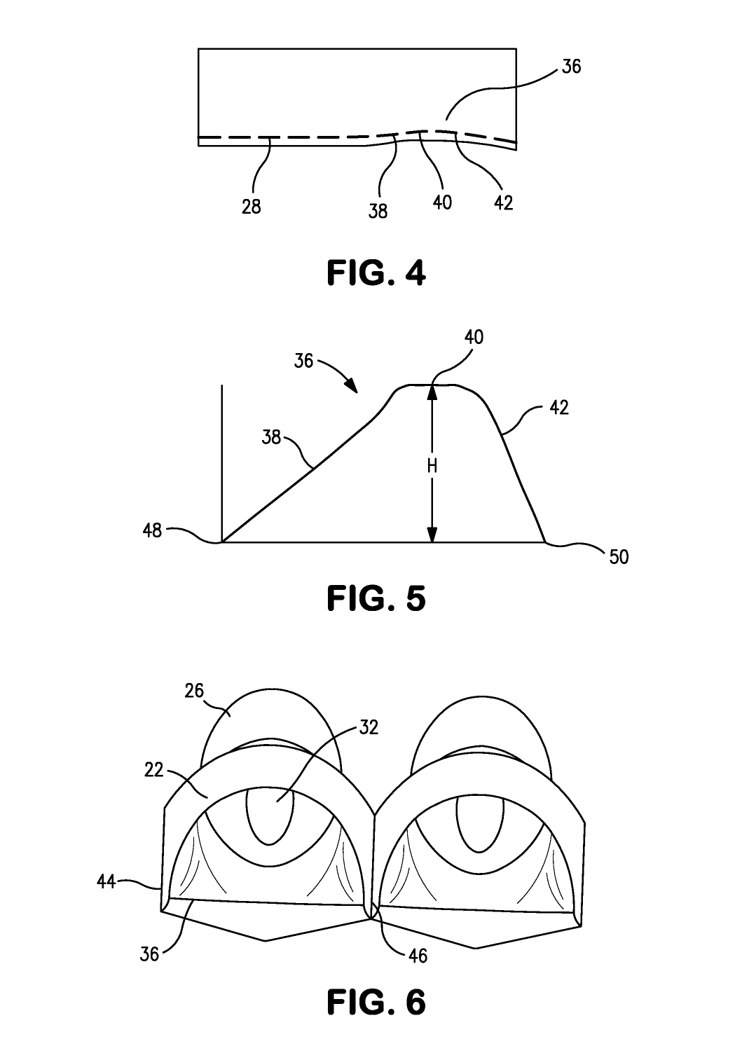

In order to modify the boundary layer flow being ingested into the inlet 20, the lower wall 28 is provided with a bump edge 36. Referring now to FIGS. 4 and 5, the bump edge 36 may be formed by creating an upwardly inclined section 38, followed by a flat portion 40, and a downwardly inclined section 42. By providing the bump edge 34, the boundary layer growth is cut.

The bump edge 36 is located downstream of, such as immediately after, the throat 34. The upwardly inclined section 38 may be at an angle of 20 to 30 degrees with respect to the surface 30. The bump edge 36 may have a height h which is 0.25% to 1.0% of the throat height H. The flat portion 40 may have a length which is about 10 to 20% of the overall length of the bump edge 36. The length of the bump edge is the distance between the location 48 where the upwardly inclined section 38 begins and the location 50 where the downwardly inclined section 42 begins to blend back into the lower wall 28.

The bump edge 36 extends from a first side wall 44 formed by the wall 22 to a second side wall 46 formed by the wall 22.

By providing the bump edge 36, distortion/flow harmonics quality at the Aerodynamic Interface Plane (AIP) is maintained for different flow conditions, different locations and different configurations. Further, Mach number flow around the leading edge inlet lip formed by the upper wall 22 is limited. Still further, corner/lip flow shedding is limited or eliminated.

The bump edge 36 helps redistribute the boundary layer ingestion upstream of the inlet 20 in a more uniform way. The smooth upstream edge where the surface 30 meets the lower wall 28 reduces the incoming boundary layer ingestion upstream of the inlet 20.

The inlet design disclosed herein ensures a smooth integration of the boundary layer ingestion inlet within the blended wing body airframe. It also ensures that the Mach number for the flow passing through and around the inlet varies smoothly, ensuring low pressure losses. The pressure losses may be kept below 0.4%. Still further, the use of a short inlet leads to weight savings. The inlet design disclosed herein forms part of a distortion tolerant propulsion system and ensures that flow field distortion profiles have limited impact on fan efficiency and reduction in stall margin.

There has been provided herein a blended wing body-boundary layer ingesting inlet design integration. While the blended wing body-boundary layer ingesting inlet design integration has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. An inlet for a propulsion system comprising:
an upper wall and a lower wall;
a throat extending between said upper wall and said lower wall; and
said lower wall having a bump edge located downstream of said throat.

2. The inlet of claim 1 wherein said bump edge has an upwardly inclined portion, a flat portion, and a downwardly inclined portion.

3. The inlet of claim 2, wherein said upwardly inclined portion is inclined at an angle of from about 20 to about 30 degrees.

4. The inlet of claim 2, wherein said flat portion extends from about 10 to about 20% of the overall length of the bump edge.

5. The inlet of claim 1, wherein said throat has a first height and said bump edge has a second height which is about 0.25 to about 1.0% of said first height.

6. The inlet of claim 1, wherein said upper wall forms a leading edge inlet lip and has an arcuate shape at said leading edge inlet lip.

7. The inlet of claim 6, wherein said upper wall forming said leading edge inlet lip has a U-shaped profile.

8. The inlet of claim 7, wherein said upper wall forming said leading edge inlet lip is joined at a trailing edge to a casing surrounding said propulsion system.

9. The inlet of claim 1, wherein said lower wall has a leading edge and is a continuation of a surface of an airframe.

10. The inlet of claim 9, further comprising a smooth transition at said leading edge of said lower wall.

11. A propulsion system comprising:
an inlet comprising
an upper wall and a lower wall;
a throat extending between said upper wall and said lower wall, said lower wall having a bump edge located downstream of said throat; and
a compressor in fluid communication with the inlet; and
a turbine configured to drive the compressor.

12. The propulsion system of claim 11, wherein said bump edge has an upwardly inclined portion, a flat portion, and a downwardly inclined portion.

13. The propulsion system of claim 12, wherein said upwardly inclined portion is inclined at an angle of about 20 to about 30 degrees.

14. The propulsion system of claim 12, wherein said flat portion extends from about 10 to about 20% of the overall length of the bump edge.

15. The propulsion system of claim 11, wherein said throat has a first height and said bump edge has a second height which is about 0.25 to about 1.0% of said first height.

16. The propulsion system of claim 11, wherein said upper wall forms a leading edge inlet lip and has an arcuate shape at said leading edge inlet lip.

17. The propulsion system of claim 16, wherein said upper wall forming said leading edge inlet lip has a U-shaped profile.

18. The propulsion system of claim 17, wherein said upper wall forming said leading edge inlet lip is joined at a trailing edge to a casing surrounding said propulsion system.

19. The propulsion system of claim 11, wherein said lower wall has a leading edge and is a continuation of a surface of an airframe.

20. The propulsion system of claim 19, further comprising a smooth transition at said leading edge of said lower wall.
